(19) United States
(12) Patent Application Publication
(10) Pub. No.: US 2016/0016395 A1
(43) Pub. Date: Jan. 21, 2016

(54) Device Structures Bonded With Adhesive Films

(71) Applicant: APPLE INC., Cupertino, CA (US)

(72) Inventors: Tyler S. Bushnell, Mountain View, CA (US); Erik G. de Jong, San Francisco, CA (US); Peter J. Kardassakis, Mountain View, CA (US); Shih-Min Hsu, Tainan City (TW)

(21) Appl. No.: 14/805,276

(22) Filed: Jul. 21, 2015

Related U.S. Application Data
(60) Provisional application No. 62/026,937, filed on Jul. 21, 2014.

(51) Int. Cl. B32B 37/12; B32B 37/06; B32B 37/14; B32B 38/00

(52) U.S. Cl. CPC B32B 37/1207; B32B 38/0012; B32B 37/06; B32B 37/14; B32B 2457/00; B32B 2310/00

(57) ABSTRACT

Adhesive may be used to bond electronic device structures together. The adhesive may be a heat activated film. Heat to activate the film may be produced by vibrating electronic device structures so that they rub against each other. An ohmic heating element may be used to produce heat under the control of circuitry inside an electronic device and may be adjusted based on temperature sensor data. Infrared light may pass through a display cover layer to activate the heat activated film. Radio-frequency signals may heat the heat activated film and may be absorbed by fibers in the film or resonant elements such as metal traces. Exothermic reactions may be used to activate the film. An ultraviolet light source may initiate curing of a solid adhesive film layer before the layer is pressed between structures to be joined. A display may produce light that cures adhesive in an electronic device.

This application claims the benefit of provisional patent application No. 62/026,937 filed on Jul. 21, 2014, which is hereby incorporated by reference herein in its entirety.

### BACKGROUND

This relates generally to electronic devices, and, more particularly, to assembling structures in electronic devices with adhesives such as adhesive film.

Electronic devices such as cellular telephones, computers, and other electronic equipment often contain structures that are bonded together using adhesive. Adhesive joints may be formed using liquid adhesive, pressure sensitive adhesive, and heat activated films. Heat activated films contain polymers that form adhesive bonds upon heating to an activation temperature. Pressure sensitive adhesives form bonds when pressure is applied. Liquid adhesives can be cured by application of ultraviolet light or heat. Some liquid adhesives are provided in two-part form and cure upon mixing.

In many situations, it may be difficult or impossible to form satisfactory adhesive joints, particularly in portions of an electronic device that are hidden from view. In some situations, liquid adhesives may wick into undesired locations. In other situations, the process of using a heat source such as an oven to apply heat to a heat activated film in an electronic device may damage sensitive structures in the electronic device. Ultraviolet light may be difficult to apply to adhesive due to the presence of intervening opaque structures.

It would therefore be desirable to be able to provide improved ways in which to form adhesive bonds when assembling electronic device structures.

### SUMMARY

Structures in an electronic device may be bonded together using adhesive. The structures that are bonded together may include a display structure such as a display cover layer or other display layer, an electronic device housing, or other device structures.

The adhesive may be a heat activated film. The heat activated film may be a flexible polymer that forms an adhesive bond when heated to a temperature that exceeds an activation temperature.

The heat activated film may be activated by heat produced by friction when vibrating electronic device structures so that they rub against each other.

Control circuitry within the electronic device may control the application of current to an ohmic heating element that is adjacent to a heat activated film. The ohmic heating element may be used to produce heat under the control of control circuitry inside the electronic device and may be adjusted based on temperature sensor data from a temperature sensor that is adjacent to the heat activated film.

Infrared light may pass through a display cover layer to activate a heat activated film. The infrared light may be produced from an infrared light source that is concentrated using filter structures, lenses, minors, a laser source, or other suitable arrangements.

Radio-frequency signals may heat the heat activated film. The heat activated film may incorporate metal fibers or other structures that enhance radio-frequency signal absorption. If desired, metal traces on a device structure may be patterned to form resonant elements that help absorb the radio-frequency signals.

### BRIEF DESCRIPTION OF THE DRAWINGS

FIG. 1 is a perspective view of an illustrative electronic device in accordance with an embodiment.

FIG. 2 is a cross-sectional side view of an illustrative electronic device in accordance with an embodiment.

FIG. 3 is a diagram of illustrative equipment involved in assembling device structures using adhesive in accordance with an embodiment.

FIG. 4 is a cross-sectional side view of illustrative vibrating equipment being used to form an adhesive joint in accordance with an embodiment.

FIG. 5 is a diagram showing how ohmic heating may be used to form an adhesive joint in accordance with an embodiment.

FIG. 6 is a diagram of an infrared light source being used to form an adhesive joint in accordance with an embodiment.

FIG. 7 is a diagram showing how radio-frequency electromagnetic signals that induce eddy currents may be used in forming an adhesive joint in accordance with an embodiment.

FIG. 8 is a diagram showing how radio-frequency electromagnetic signals that are absorbed by absorption structures in a heat activated film may be used to produce heat to form an adhesive joint in accordance with an embodiment.

FIG. 9 is a cross-sectional side view of an illustrative radio-frequency source that is being absorbed using resonant elements adjacent to an adhesive layer to form an adhesive joint in accordance with an embodiment.

FIG. 10 is a cross-sectional side view of structures being joined using an exothermic chemical reaction that produces heat for an adhesive joint in accordance with an embodiment.

FIG. 11 is a perspective view of an illustrative layer of material with grooves for exothermic reaction chemicals in accordance with an embodiment.

FIG. 12 is a cross-sectional side view of structures being joined by an adhesive that is heated using an exothermic reaction from chemicals that have been mixed together upon being released from crushed microspheres in accordance with an embodiment.

FIGS. 13 and 14 are side views of structures being joined by applying ultraviolet light to adhesive before the structures are pressed together in accordance with an embodiment.

FIG. 15 is a cross-sectional side view of an illustrative electronic device in which an adhesive joint is being formed by curing adhesive using light from an internal component such as a display in accordance with an embodiment.

### DETAILED DESCRIPTION

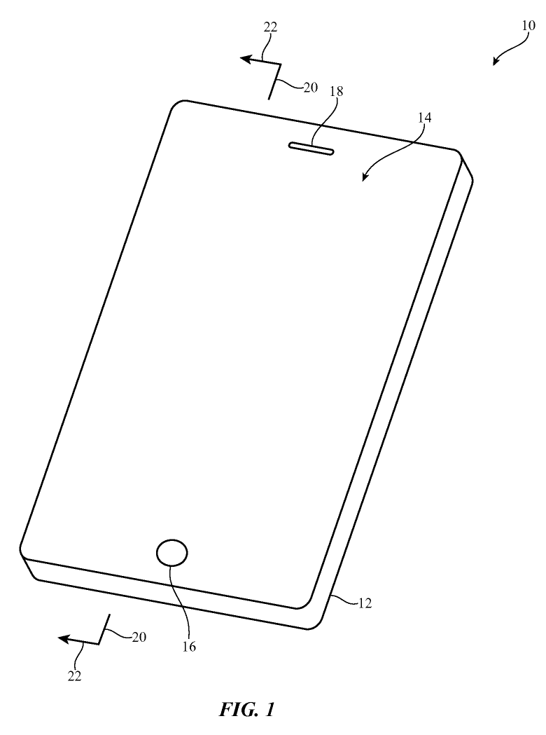

An electronic device such as electronic device 10 of FIG. 1 may contain structures that are bonded using adhesive. The adhesive that is used in bonding the structures together may include liquid adhesive, pressure sensitive adhesive, and/or solid adhesive films such as films of thermal bonding adhesive (sometimes referred to as heat activated films).

Heat activated films may be formed from layers of adhesive material such as thermoplastic polymers, thermoset polymers, and/or combinations of thermoset and thermoplastic polymeric materials. Heat activated films may be used to make strong adhesive joints when raised above a predetermined activation temperature (e.g., 120° C. or other suitable temperature). To prevent damage to sensitive nearby components, it may be desirable to selectively heat portions of device 10 in the vicinity of the heat activated film, while minimizing temperature rises in the sensitive components (e.g., to less than 80° C. or less than 60° C., as examples).

Selective heating techniques and other adhesive joint formation techniques may sometimes be described herein in the context of bonding electronic device structures in electronic device 10 together using adhesives such as heat activated films. In general, however, any suitable adhesive may be used for joining any suitable structures together. The attachment of electronic device structures using adhesives such as heat activated film adhesives is merely illustrative.

Electronic device 10 may be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. In the illustrative configuration of FIG. 1, device 10 is a portable device such as a cellular telephone, media player, tablet computer, or other portable computing device. Other configurations may be used for device 10 if desired. The example of FIG. 1 is merely illustrative.

In the example of FIG. 1, device 10 includes a display such as display 14 mounted in housing 12. Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures.

Display 14 may include an array of display pixels formed from liquid crystal display (LCD) components, an array of electrophoretic display pixels, an array of plasma display pixels, an array of organic light-emitting diode display pixels or other light-emitting diodes, an array of electrowetting display pixels, or display pixels based on other display technologies.

Display 14 may be protected using a display cover layer such as a layer of transparent glass or clear plastic. Openings may be formed in the display cover layer. For example, an opening may be formed in the display cover layer to accommodate a button such as button 16. An opening may also be formed in the display cover layer to accommodate ports such as speaker port 18. Openings may be formed in housing 12 to form communications ports (e.g., an audio jack port, a digital data port, etc.), to form openings for buttons, etc.

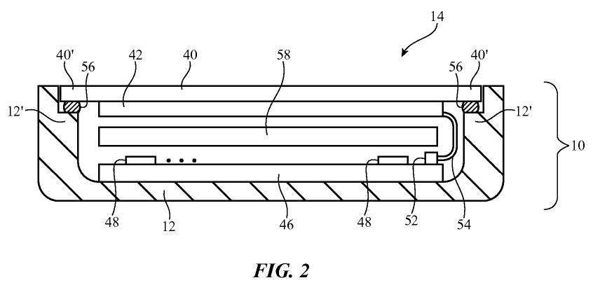

A cross-sectional side view of electronic device 10 of FIG. 1 taken along line 20 and viewed in direction 22 is shown in FIG. 2. As shown in FIG. 2, display 14 of device 10 may be formed from a display module such as display module 42 mounted under a cover layer such as display cover layer 40 (as an example). Display 14 (display module 42) may be a liquid crystal display, an organic light-emitting diode display, a plasma display, an electrophoretic display, a display that is insensitive to touch, a touch sensitive display that incorporates and array of capacitive touch sensor electrodes or other touch sensor structures, or may be any other type of suitable display. Display cover layer 40 may be layer of clear glass, a transparent plastic member, a transparent crystalline member such as a sapphire layer, or other clear structure.

Device 10 may have inner housing structures that provide additional structural support to device 10 and/or that serve as mounting platforms for printed circuits and other structures. Structural internal housing members may sometimes be referred to as housing structures and may be considered to form part of housing 12.

Electrical components 48 may be mounted within the interior of housing 12. Components 48 may be mounted to printed circuits such as printed circuit 46. Printed circuit 46 may be a rigid printed circuit board (e.g., a printed circuit board formed from fiberglass-filled epoxy or other rigid printed circuit board material) or may be a flexible printed circuit (e.g., printed circuit formed from a sheet of polyimide or other flexible polymer layer). Patterned metal traces within printed circuit board 46 may be used to form signal paths between components 48. If desired, components such as connectors may be mounted to printed circuit 46. As shown in FIG. 2, for example, a cable such as flexible printed circuit cable 54 may couple display module 42 to connector 52. Connector 52 may couple cable 54 to traces within printed circuit 46. When coupled as shown in FIG. 2, signals associated with operation of display 42 may pass to display 42 from signal lines in printed circuit 46 through cable 54 and connector 52.

In addition to components 48, device 10 may have internal components such as component 58. Components such as component 58 may include sensors, wireless circuitry, integrated circuits, input-output devices such as status indicator lights, microphones, speakers, vibrators, tone generators, accelerometers, radio-frequency transceiver circuitry, power amplifier circuitry, switches, filters, batteries, etc. As an example, component 58 may be a battery that is used to supply power to circuitry 48 on printed circuit 46 and other internal circuitry.

During assembly operations, structures in device 10 such as display cover layer 40 and housing 12 may be assembled together. Display cover layer 40 may be, for example, a layer of clear glass or plastic. Housing 12 may be formed from metal, glass, ceramic, plastic, fiber-composites such as carbon fiber material, etc. Adhesive such as heat activated film 56 may be interposed between portions 40′ of display cover layer 40 and portions 12′ of housing 12 (or other suitable structures in device 10). If desired, a layer of black ink or other opaque masking material may be interposed between the inner surface of display cover layer 40 and heat activated film 56 to help block internal components from view by a user of device 10 and/or to prevent stray light from display 42 from escaping the interior of device 10.

Heat activated film 56 may be heated to a temperature sufficient to activate heat activated film 56 and thereby form an adhesive bond between portions 40′ of display cover layer 40 in display 14 and portions 12′ in housing 12. With one suitable arrangement, local heating is used to avoid over-heating nearby sensitive components in device 10. Examples of sensitive components in the vicinity of heat activated film 56 include display 14 (i.e., display module 42), components 48, battery 58 (or other electrical components), the attachment structures associated with attaching cable 54 to the layers of display 42 (e.g., sensitive anisotropic conductive film connections between cable 54 and a thin-film transistor layer in module 42), etc. Localized heating operations may be performed on structures to be bonded to prevent excess heating that might damage sensitive components. As an example, heat activated film 56 of FIG. 2 may be heated to a temperature of over 120° C. (or other suitable temperature) while ensuring that the sensitive components in device 10 such as display module 42, battery 58, cable 54, and components 48 remain at temperatures of less than 60° C. (or other suitable temperature). Arrangements for processing blanket adhesive layers (e.g., solid adhesive films) using ultraviolet light and heat generated by exothermic chemical reactions may also be used.

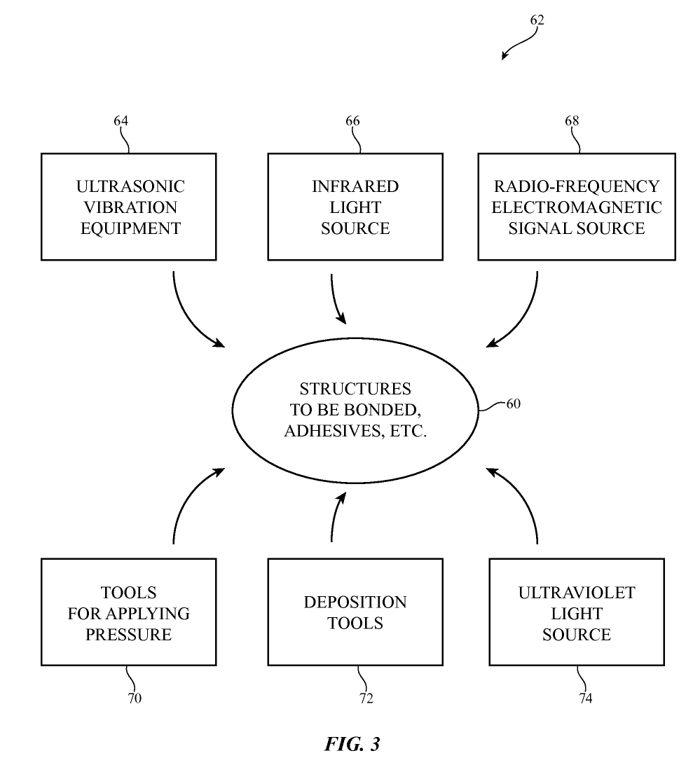

Illustrative equipment for processing adhesive to join device structures together is shown in FIG. 3. As shown in FIG. 3, processing equipment 62 may be used to process structures and adhesive 60. Structures and adhesive 60 may include electronic device structures that are to be bonded together such as display cover layer 40 and housing 12 of FIG. 2. Structures and adhesive 60 may also include adhesive such as heat activated film 56 or other adhesive.

Equipment 62 may include ultrasonic vibration equipment 64. Ultrasonic vibration equipment 64 may be used to vibrate a first structure relative to a second structure, thereby forming heat resulting from friction and movement between portions of the first and second structures. The heat produced from the friction between the first and second structures as the first and second structures are rubbed together by vibration equipment 64 may be used to raise heat activated film 56 above its activation temperature. The portions of the surfaces of the first and second structures that contact each other during rubbing may be relatively limited (e.g., peripheral edge portions of display cover layer 40 such as portions 40′ that rub against opposing portions of housing 12 such as portions 12′, etc.), so excess heat is not generated that might damage sensitive components.

Infrared light source 66 may include a source of infrared light (e.g., light at 0.7 microns in wavelength to 0.1 mm in wavelength, light with a wavelength longer than 0.7 microns, etc.). Light source 66 may be based on an infrared laser such as an infrared laser diode or other infrared laser, an infrared lamp, or other infrared light source. Filters (e.g., infrared blocking filters), baffles, lenses, planar mirrors, convex mirrors, and/or concave mirrors, or other optical components may be used in concentrating and focusing infrared light from infrared light source 66.

Radio-frequency electromagnetic signal source 68 may be based on a radio-frequency signal generator, an optional radio-frequency amplifier, and one or more antennas that wireless transmit the radio-frequency signals structures and adhesive 60. Radio-frequency signals from structures 68 may have frequencies of tens or hundreds of MHz or may have frequencies in the GHz range or higher (as examples).

Tools 70 may include fixtures that are moved using computer-controlled positioners, presses, lamination equipment, and other movable structures that can press layers of material together in device 10 or that can press other electronic device structures towards each other during adhesive bonding.

Deposition tools 72 may be used to deposit heat activated film, liquid adhesive, pressure sensitive adhesive, adhesive curing catalyst, reactants for forming exothermic reactions when mixed together or when mixed with adhesive, etc. Tools 72 may include ink-jet printing equipment, pad printing equipment, screen printing equipment, nozzles, roller equipment (e.g., equipment for rolling films of adhesive or portions of adhesive films onto structures to be joined), computer-controlled grippers or other equipment that applies adhesive tape or other adhesive to parts to be joined, and other equipment for depositing materials associated with forming adhesive joints in device 10.

Ultraviolet light source 74 may be used to produce ultraviolet light. Light source 74 may be based on an ultraviolet lamp (e.g., a mercury lamp), may be based on an ultraviolet laser, may be based on light-emitting diodes, or may be based on other source(s) of ultraviolet light.

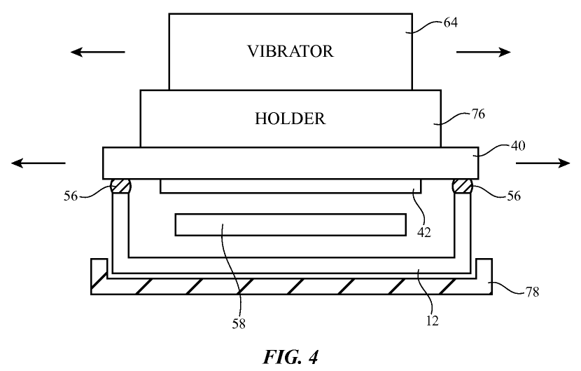

FIG. 4 shows how friction may produce heat that activates heat activated film 56. In the example of FIG. 4, structure 40 (e.g., a display cover layer or other display layer) is being joined with structure 12 (e.g., an electronic device housing) using heat activated film 56. Holder 76 may be a vacuum holder, a mechanical fixture that grips structure 40, or other structure that engages structure 40. Structure 12 may be held in place within stationary fixture 78 (as an example). Vibrator 64 may vibrate laterally (horizontally in the orientation of FIG. 4) at ultrasonic frequencies or other suitable vibration frequencies. Holder 76 may be attached to vibrator 64, so that the vibrations produced by vibrator 64 are conveyed to structure 40. This causes the edges of structure 40 to rub back and forth against heat activated film 56 and/or structure 12. The friction associated with the rubbing contact between structure 40 and the structures (i.e., structure 12 and/or heat activated film 56) produces heat that activates heat activated film 56 and thereby bonds structures 40 and 12 together. Because heat is produced locally in the regions subject to rubbing and friction, sensitive components such as display module 42 and other sensitive components in device 10 will not be subjected to excessive temperatures. Although the structures being bonded in the example of FIG. 4 include display cover layer 40 and housing 12, in general any suitable device structures may be bonded using heat from vibration and friction. The configuration of FIG. 4 is merely illustrative.

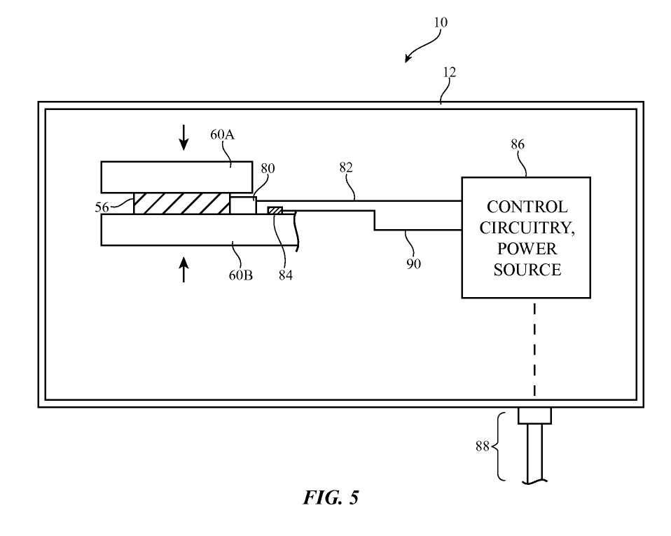

In the illustrative example of FIG. 5, ohmic heating is being used to activate heat activated film 56. Device 10 has a housing such as housing 12. Circuitry such as circuitry 86 that is mounted within housing 12 may include control circuitry and a power source. The control circuitry and power source may be used in controlling the application of heat to heat activated film 56. Circuitry 86 may include control circuitry such as one or more microprocessors, microcontrollers, digital signal processing circuits, application-specific integrated circuits with control capabilities, or other controller or processing circuitry. The control circuitry may include storage circuitry such as random-access memory, read-only memory, etc. Code that is stored in the storage circuitry may be executed by the processing circuitry to implement desired control functions in device 10. Circuitry 86 may contain a power source such as battery 58 or a power management unit or other circuitry that supplies the control circuitry with power from an external source such as cable 88.

As shown in FIG. 5, heat activated film 56 may be interposed between structures 60A and 60B. Structures 60A and 60B may be structures such as display cover layer 40 and housing 12 or other structures to be bonded together in device 10. During bonding, pressure may be applied to the structures being bonded using tools 70 or other techniques. A heating element such as ohmic heating element 80 may be formed in the vicinity of heat activated film 56 (e.g., embedded within film 56, adjacent to film 56, under film 56, etc.). Ohmic heating element 80 may be formed from metal traces on structure 60A, metal traces on structure 60B, wire, and/or metal traces, metal foil, wire, or other conductive material on other support structures. Ohmic heating element 80 is preferably sufficiently resistive to generate heat by ohmic heating when a current is supplied to heating element 80 through path 82. The shape of ohmic heating element 80 may be elongated (e.g., heating element 80 may be formed from an elongated strip of conductive material) or may have other suitable shapes. As an example, in a scenario in which heat activated film 56 has a ring shape that runs around the periphery of display cover layer 40 and housing 12, heating element 80 may have a ring (loop) shape that runs parallel to heat activated film 56. Configurations in which heating element 80 and heat activated film 56 have other shapes (e.g., straight strips, zig-zag shapes, etc.) may also be used.

If desired, a thermal sensor such as sensor 84 (e.g., a thermocouple, a sensor based on a semiconductor device, or other thermal sensor component) may be mounted in device 10 in the vicinity of heat activated film 56 and ohmic heating element 80. Circuitry 86 can gather temperature measurements from sensor 84 over path 90 in real time during activation of heat activated film 56.

When it is desired to bond structures 60A and 60B together, circuitry 86 can apply current to ohmic heating element 80 using path 82. The current can be supplied using a battery within device housing 12 or by internally distributing power that is being received from cable 88 or other external source. Circuitry 86 in device 10 can be used to control the duration and intensity of the applied current using an open-loop control scheme or based on temperature feedback information such as real time temperature measurements made using path 90 and temperature sensor(s) 84. When temperature sensor data is used, situations involving insufficient heating or excessive heating can be avoided.

The current that is supplied to ohmic heating element 80 heats ohmic heating element 80 and thereby heats adjacent structures such as heat activated film 56. Ohmic heating element 80 preferably applies sufficient heat to heat activated film 56 to raise heat activated film 56 above a predetermined activation temperature (i.e., a temperature of 120° C. or other suitable threshold temperature). When activated in this way, heat activated film 56 will form a satisfactory adhesive joint between structures 60A and 60B. Because circuitry 86 and ohmic heating element 80 are located within device housing 12, the exterior of device housing 12 is protected from potential wear and damage during heating operations. The use of ohmic heating element 80 may also allow temperature rises in device 10 to be localized sufficiently to prevent excessive heating of nearby sensitive components in device 10.

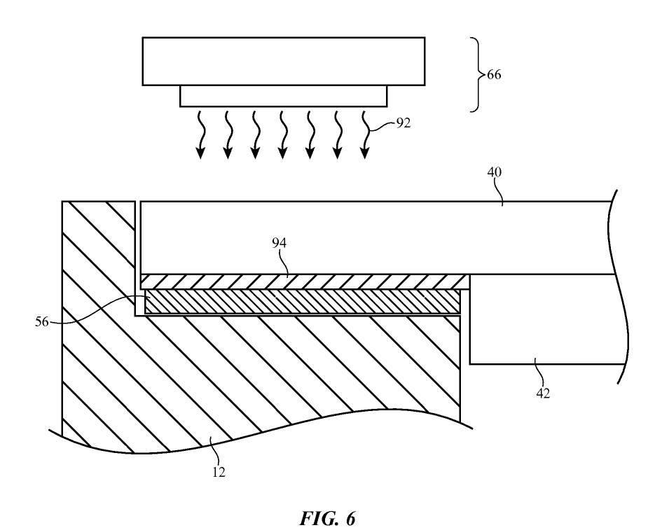

FIG. 6 is a side view of illustrative device structures that are being bonded to each other by using infrared light 92 from infrared light source 66 to apply heat to heat activated film 56. The structures that are being joined in the example of FIG. 6 include display cover layer 40 and housing 12. This is merely illustrative. In general, any suitable structures to be joined may be bonded together using heat activated film 56 that is heated by infrared light 92.

As shown in FIG. 6, heat activated film 56 may be interposed between display cover layer 40 and housing 12. If desired, a layer of opaque masking material such as black ink 94 may be interposed between display cover layer 40 and housing 12. Black ink layer 94 may help shield internal device components from view by a user of device 10 and may be used to prevent stray backlight from escaping device 10. If desired opaque masking layer 94 may have a color other than black (e.g., layer 94 may be white, silver, gray, gold, red, blue, green, etc.). Layer 94 may form a coating that is adhered to the underside of display cover layer 40. Because layer 94 is attached to layer 40, display cover layer 40 may be attached to housing structure 12 or other suitable structures using heat activated film 56 that is located adjacent to layer 94.

A light source such as infrared light source 66 may produce light 92 to raise the temperature of heat activated film 56 above its activation temperature. Light 92 may be infrared light at wavelengths between 0.7 microns and 0.1 mm or may have other suitable wavelengths. During bonding, light 92 may be focused or otherwise selectively applied to the portion of device 10 containing the structures to be bonded (i.e., the portion of device 10 containing the edge of display cover layer 40, heat activated film 56, and the corresponding edge of housing 12. The wavelength of light 92 may be selected so that light 92 is absorbed exclusively in one of the layers of FIG. 6 (e.g., display cover layer 40, opaque masking layer 94, heat activated film 56, or housing 12) or may be selected so that light 92 is absorbed by two or more of these structures. As an example, light 92 may pass through transparent display cover layer 40 without significant attenuation before being absorbed by heat activated film 56 and underlying portions of housing 12. Some of light 92 may be absorbed by opaque masking layer 94 or layer 94 may be configured to be transparent at infrared wavelengths. Light 92 can be applied locally to help prevent excessive temperature rise in nearby sensitive components such as display module 42 and other sensitive circuitry.

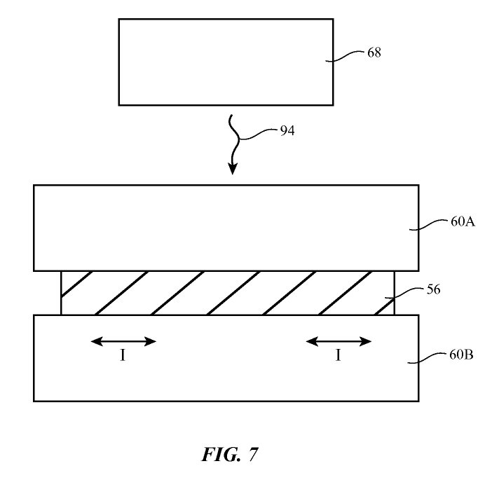

FIG. 7 is a side view of an illustrative system in which radio-frequency signals 94 are being applied to heat activated film 56 using radio-frequency source 68. Signals 94 may, if desired, be provided locally in the vicinity of heat activated film 56, to help avoid disrupting the operation of sensitive components in device 10 such as display module 42. Signal absorption and heating can also be localized by selectively forming radio-frequency signal absorbing structures in areas where heating is desired.

Source 68 may include a radio-frequency signal generator and one or more antennas to deliver radio-frequency signals from the signal generator. Radio-frequency signals 94 may be absorbed directly by heat activated film 56 and/or may be absorbed by adjacent structures such as structures 60A and 60B. When absorbed in heat activated film 56, radio-frequency signals may heat film 56. When absorbed in adjacent structures such as illustrative structure 60B in the example of FIG. 7, eddy currents I may be induced in structure 60B (e.g., structure 60B may be a metal housing in which eddy currents are produced in the presence of radio-frequency signals 94). The eddy currents can give rise to heating in layer 60B. When the temperature of layer 60B is increased, the temperature of heat activated film 56 also increases. When sufficient radio-frequency signal power is supplied to heat activated film 56 and/or adjacent structures such as structures 60A and 60B of FIG. 7, heat activated film 56 will be heated above a predetermined activation point, thereby forming an adhesive joint that bonds structures 60A and 60B together.

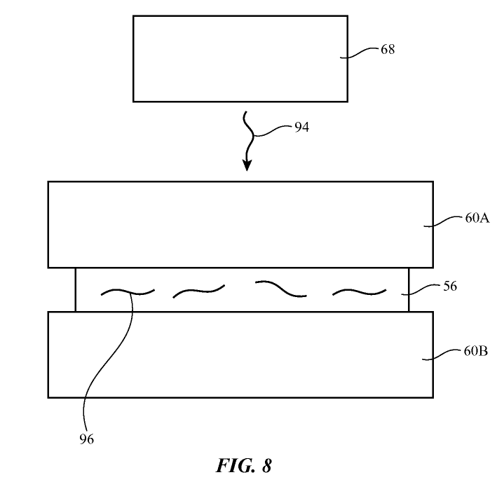

If desired, materials may be incorporated into heat activated film 56 or adjacent electronic device structures to enhance the absorption of radio-frequency signals 94. Signals 94 may have any suitable frequency. For example, signals 94 may have frequencies above 1 MHz, frequencies above 1 GHz, etc. As shown in FIG. 8, radio-frequency signal absorbing structures such as fibers 96 may be incorporated into heat activated film 56. Fibers 96 may be metal fibers or other conductive materials having shapes and sizes that promote interaction with radio-frequency signals 94. For example, signals 94 may have a frequency associated with a wavelength λ and fibers 96 may have a length of λ/4 or other suitable length that causes signals 94 to be absorbed within heat activated film 56. When radio-frequency signals 94 are applied, fibers 96 or other filler material in heat activated film 56 (e.g., metal powder, etc.) may enhance radio-frequency signal absorption and heating of heat activated film 56, without heating nearby sensitive components (e.g., without heating display module 42 in a scenario in which structure 60A is a display cover layer and structures 60B is a portion of housing 12). The heat rise in heat activated film 56 is preferably sufficient to activate heat activated film 56 and thereby form an adhesive joint between structures 60A and 60B. Because heat is generated locally (either in film 56 or in adjacent portions of structures 60A and 60B), sensitive components will not be damaged.

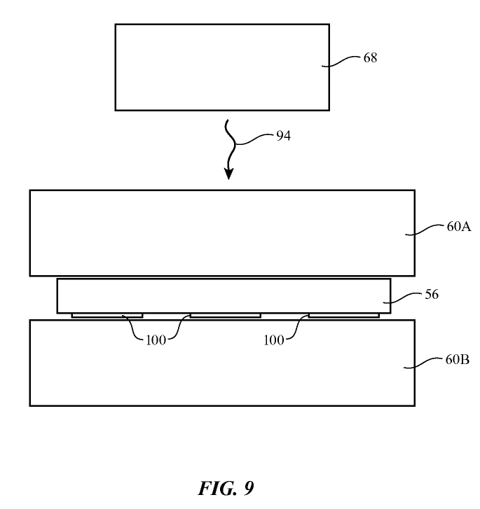

In the illustrative configuration of FIG. 9, structure 60B has been provided with a patterned coating of metal traces such as metal traces 100. Metal traces 100 may form resonant elements that are tuned to enhance signal absorption of radio-frequency signals 94. Traces 100 may, for example, be metal strips that have a particular length (e.g., λ/4, etc.), may be spirals or loops that serve as inductive elements that individually or in combination with capacitors or other circuitry form resonant circuits that are tuned to absorb signals 94, or may form other tuned circuits that enhance signal absorption and therefore enhance the ability of signals 94 to raise the temperature of heat activated film 56. In the example of FIG. 9, resonant circuit structures 100 have been implemented by forming patterned metal traces on the upper surface of structure 60B. If desired, resonant circuit structures 100 may be formed on structure 60A or may be formed on both structures 60A and 60B. By enhancing signal absorption in structures 100, heat activated film 56 may be heated effectively by radio-frequency signals 94 from radio-frequency signal source 68 without excessively heating nearby sensitive components (e.g., display 42, etc.). The activation of heat activated film 56 causes film 56 to form an adhesive joint that bonds structures 60A and 60B together.

Exothermic chemical reactions may be used to produce heat to activate heat activated film 56. For example, first and second reactants can be mixed together. When the first and second reactants react with each other heat is released that can activate heat activated film 56 and thereby form an adhesive joint that bonds structures 60A and 60B together. The first and second reactants may be, for example, iron and oxygen, zinc and hydrochloric acid, or calcium oxide and water (as examples). Other exothermic reactions may be used in releasing heat to heat film 56 if desired.

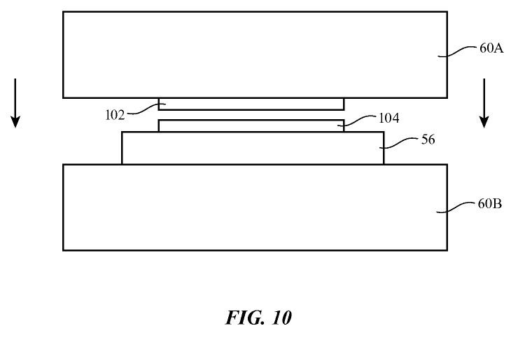

Chemical reactants for supporting an exothermic reaction can be provided on mating surfaces in the vicinity of heat activated film 56. As shown in FIG. 10, for example, a first exothermic reaction reactant such as reactant 102 may be formed as a coating on structure 60A and a second exothermic reaction reactant such as reactant 104 may be formed as a coating on the upper surface of heat activated film 56. Heat activated film 56 may be placed between structures to be bonded such as structures 60A and 60B. Because reactant layers 102 and 104 are formed on opposing surfaces, reactant layers 102 and 104 come into contact with each other and react to release heat when structures 60A and 60B are pressed together (e.g., using equipment 70). The released heat is used to raise the temperature of heat activated film 56 above the activation temperature of heat activated film 56. This forms an adhesive bond that joins structures 60A and 60B together. To ensure that heat production is localized, reactant 102 and/or reactant 104 can be formed only in preselected locations. Blanket films of reactant can also be used to produce heat. For example, blanket reactant layers can produce heat that raises the temperature of a blanket layer of heat activated film.

The first and second reactants that are used in producing the exothermic reaction can be provided on mating surfaces of the heat activated film and structures being joined (as shown in the example of FIG. 10), may be incorporated into structures such as structure 60A and/or structure 60B, may be incorporated into heat activated film 56, etc. The configuration of FIG. 10 in which reactant layers 102 and 104 are interposed between the upper surface of heat activated film 56 and the lower surface of upper structure 60A is merely illustrative.

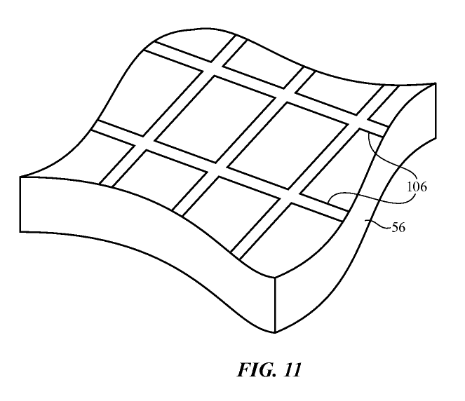

FIG. 11 shows how heat activated film 56 may be patterned to form openings such as openings 106. Openings 106 may include randomly distributed openings, an array of dots, a grid of channels (as shown in FIG. 11), or may include openings of other shapes in the surface of heat activated film 56. Reactant can be placed in openings 106 instead of covering the surface of heat activated film 56 with reactant. For example, reactant 104 may be placed in a grid-shaped pattern of openings 106 and reactant 102 can be deposited on a mating surface using a matching grid-shaped pattern, using a blanket film, or using an additional patterned layer of heat activated film (e.g., a mating film with mating grooves containing reactant 102). When structures 60A and 60B are pressed together, the reactants will produce heat that activates heat activated film 56. Because the exothermic reaction produced by mixing reactants 102 and 104 is confined to particular lateral locations (in this example), the integrity and strength of the adhesive bonds formed by heat activated film 56 will not be affected by the presence of reaction byproducts.

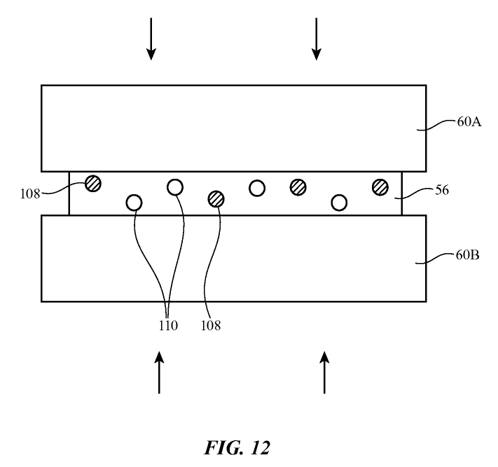

Hollow structures such as burstable beads (microspheres) may be filled with reactant. As shown in FIG. 12, for example, beads 108 may be filled with a first exothermic reaction reactant and beads 110 may be filled with a second exothermic reaction reactant. When structures 60A and 60B are pressed together, beads 108 and 110 will be crushed and will release the reactants. As the first and second reactants react with each other, heat will be released that activates heat activated film 56 and thereby forms an adhesive joint between structures 60A and 60B.

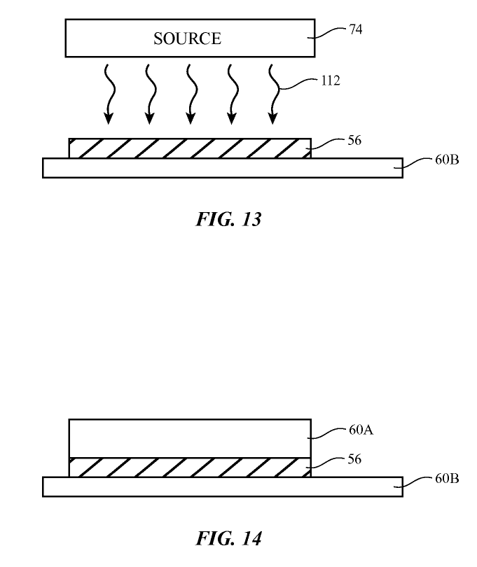

FIG. 13 shows how adhesive film (e.g., a solid uncured ultraviolet-light-curable adhesive film) may be exposed to ultraviolet light 112 from ultraviolet light source 74. Adhesive film 56 of FIG. 13 may be a solid uncured polymer layer that contains a photoinitiator. When exposed to ultraviolet light 112 (or, if desired, visible light), the photoinitiator produces reactive species that promote polymer cross-linking and thereby cure adhesive 56. There is a predictable time delay between exposure to ultraviolet light 112 and full curing of adhesive 56 (e.g., seconds or minutes). To bond structures 60A and 60B together, structure 60A may be pressed onto adhesive 56 as shown in FIG. 14 immediately after exposing adhesive 56 to ultraviolet light 112 (i.e., adhesive 56 may be exposed before pressing structures 60A and 60B together). Due to the exposure of adhesive 56 to ultraviolet light 112 of FIG. 13, adhesive 56 of FIG. 14 will cure and form an adhesive joint between structures 60A and 60B. Adhesive 56 may be formed from a solid roll of adhesive material that is cut into a desired shape before being placed on structure 60B and being exposed to ultraviolet light 112. The use of solid adhesive films such as ultraviolet-light curable adhesive film 56 of FIGS. 13 and 14 helps avoid undesired spreading of the type that may occur with liquid adhesives.

In some situations, it may be difficult or impossible to apply adhesive curing light 112 (ultraviolet or visible) to adhesive 56 from an external source such as light source 74 of FIG. 13. For example, when attaching display 14 to housing 12 in a final device assembly operation, no light pathways may be available between the exterior of device 10 and the interior portions of device 10 at which adhesive 56 is located.

To address this challenge, visible or ultraviolet light 112 can be generated internally within device 10 and housing 12. Light 112 may be generated by light sources such as one or more lamps, light-emitting diodes, or other light producing devices. The light producing electronic component that generates light 112 may be a display, a status indicator light, a button illumination light, a camera flash, a light that is used in forming a light-based wireless communications link, or other electronic component that outputs light during its operation (e.g., during normal operation for supporting its intended function within device 10).

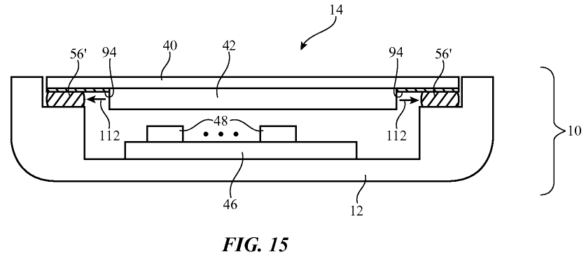

With one suitable arrangement, the internal light generating component in device 10 is a display. As shown in the example of FIG. 15, display module 42 may produce light 112 that can be used in curing adhesive 56′. Light 112 may be visible light (e.g., blue light, white light, etc.) or other suitable light. Adhesive 56′ may be light-curable solid adhesive, light-curable liquid adhesive (e.g., visible-light-cured epoxy or acrylic adhesive), or other suitable adhesive.

During assembly operations (e.g., a final assembly step), an internal electronic component that generates light such as display 14 may be placed within housing 12 so that adhesive 56′ is interposed between display cover layer 40 or other portion of display 14 and housing 12 or other portion of device 10 (as an example). Control circuitry within device 10 (see, e.g., control circuitry and power source 86 of FIG. 5) may then be used to turn on display 14 (e.g., a light-emitting-diode-based backlight unit in display module 42). The light-emitting diodes in the backlight of display module 42 or other light-emitting components in display 14 produce light 112 in response to being activated by the control circuitry. Light 112 strikes light-curable adhesive 56′ and cures adhesive 56′. When cured, adhesive 56′ forms an adhesive joint that bonds display cover layer 40 to housing 12. After curing, display 14 (or other light-producing component that was used by control circuitry 86 to generate light 112 to cure adhesive 56′) can be used normally. For example, display 14 may be used to display images for a user of device 10. Because the component within the interior of housing 12 and device 10 that is used to generate light 112 also performs display functions or other functions that support the normal operation of device 10, no additional hardware is needed for device 10 to produce light 112, although additional light sources may be added, if desired.

The foregoing is merely illustrative and various modifications can be made by those skilled in the art without departing from the scope and spirit of the described embodiments. The foregoing embodiments may be implemented individually or in any combination.

What is claimed is:

1. A method, comprising:
placing a layer of heat activated film between a first electronic device structure and a second electronic device structure; and
vibrating the first electronic device structure relative to the second electronic device structure to generate heat through friction that activates the heat activated film and bonds the first electronic device structure to the second electronic device structure.

2. The method defined in claim 1 wherein vibrating the first electronic device structure relative to the second electronic device structure comprises vibrating the first electronic device structure at an ultrasonic frequency.

3. The method defined in claim 1 wherein the second electronic device structure comprises an electronic device housing and wherein vibrating the first electronic device structure relative to the second electronic device structure comprises vibrating the first electronic device structure relative to the electronic device housing.

4. The method defined in claim 1 wherein the first electronic device structure comprises a display and wherein vibrating the first electronic device structure relative to the second electronic device structure comprises vibrating the display relative to the second electronic device structure.

5. An electronic device, comprising:
a first electronic device structure;
a second electronic device structure;
a heat activated film that bonds the first electronic device structure to the second electronic device structure;
an ohmic heating element that supplies heat to the heat activated film; and
a temperature sensor adjacent to the heat activated film that collects temperature measurements on the heat activated film while the ohmic heating element activates the heat activated film.

6. The electronic device defined in claim 5 further comprising:
control circuitry that applies current to the ohmic heating element to heat the heat activated film.

7. The electronic device defined in claim 6 further comprising a battery that supplies power to the control circuitry that the control circuitry uses to apply the current.

8. The electronic device defined in claim 6 further comprising an electronic device housing in which the control circuitry is located, wherein the control circuitry adjusts the current based on information from the temperature sensor.

9. A method, comprising:
placing a layer of heat activated film between a first electronic device structure and a second electronic device structure; and
with an infrared light source, supplying infrared light that passes through the first electronic device structure to heat the heat activated film and activate the heat activated film to form an adhesive joint that bonds the first electronic device structure to the second electronic device structure.

10. The method defined in claim 9 wherein the first electronic device structure comprises a display layer and wherein supplying the infrared light comprises supplying the infrared light to the display layer so that the infrared light passes through the display layer.

11. A method, comprising:
placing a layer of heat activated film between a first electronic device structure and a second electronic device structure; and
with a radio-frequency source, supplying radio-frequency signals that heat the heat activated film and activate the heat activated film to form an adhesive joint that bonds the first electronic device structure to the second electronic device structure.

12. The method defined in claim 11 wherein supplying the radio-frequency signals comprises applying the radio-frequency signals to resonant elements that absorb the radio-frequency signals and heat the heat activated film.

13. The method defined in claim 11 wherein the second electronic device structure comprises a metal structure and wherein supplying the radio-frequency signals comprises inducing currents in the metal structure to heat the heat activated film.

14. The method defined in claim 11 wherein the heat activated film includes fibers and wherein supplying the radio-frequency signals comprises applying signals that are absorbed by the fibers to heat the heat activated film.

15. A method, comprising:
placing a layer of heat activated film between a first electronic device structure and a second electronic device structure; and
mixing a first reactant with a second reactant to produce an exothermic reaction that heats the heat activated film and activates the heat activated film to form an adhesive joint that bonds the first electronic device structure to the second electronic device structure.

16. The method defined in claim 15 further comprising:
before mixing the first reactant with the second reactant, coating a surface of the first electronic device structure with the first reactant and coating a surface of the heat activated film with the second reactant.

17. The method defined in claim 15 wherein the first and second reactants are enclosed in burstable beads in the heat activated film and wherein mixing the first reactant with the second reactant comprises bursting the beads.

18. The method defined in claim 15 wherein the heat activated film comprises openings, the method further comprising placing the first reactant in the openings before mixing the first reactant with the second reactant.

19. A method, comprising:
coating a first electronic device structure with a solid adhesive film that contains a photoinitiator;
exposing the solid adhesive film to ultraviolet light to initiate curing of the solid adhesive film; and
pressing the solid adhesive film that has been exposed to the ultraviolet light between the first electronic device structure and a second electronic device structure to bond the first and second electronic device structures together as the solid adhesive film cures.

20. A method, comprising:
assembling an electronic device so that a light-curable adhesive is interposed between a first electronic device structure and a second electronic device structure; and
turning on a display in the electronic device that produces light that cures the light-curable adhesive and bonds the first electronic device structure to the second electronic device structure.

21. The method defined in claim 20 wherein the first electronic device structure comprises a display cover layer and wherein turning on the display comprises producing light that bonds the display cover layer to the second electronic device structures.
